(19) United States
(12) Patent Application Publication
(10) Pub. No.: US 2011/0250474 A1
(43) Pub. Date: Oct. 13, 2011

(54) SECONDARY BATTERY

(75) Inventors: Woong-Seong Baek, Yongin-si (KR); Sang-Jin Park, Yongin-si (KR); Woody Kim, Yongin-si (KR)

(73) Assignee: Samsung SDI Co., Ltd., Yongin-si (KR)

(21) Appl. No.: 13/079,708

(22) Filed: Apr. 4, 2011

Related U.S. Application Data
(60) Provisional application No. 61/323,752, filed on Apr. 13, 2010.

(51) Int. Cl. H01M 10/42

(52) U.S. Cl. 429/7

(57) ABSTRACT

A secondary battery comprises a bare cell comprising an electrode assembly and a pouch housing the electrode assembly, wherein the bare cell comprises a first side at one end of the bare cell; a molded portion covering at least a part of the first side of the bare cell; and a circuit module disposed over the molded portion.

### RELATED APPLICATIONS

This application claims priority to and the benefit of U.S. Provisional Application No. 61/323,752 filed on Apr. 13, 2010, the entire content of which is incorporated herein by reference.

### BACKGROUND

1. Field

Embodiments of the invention relates to a secondary battery. In particular, embodiments are directed to a secondary battery having an improved combination of a bare cell and a printed circuit module.

2. Description of the Related Art

Many studies on secondary batteries are performed in various fields, since there are many applications for secondary batteries. In particular, lithium ion secondary batteries typically have an operation voltage of 3.7V, which is three times higher than nickel-cadmium batteries and nickel-hydrogen batteries. Because it provides higher energy intensity per unit weight, the use of lithium ion secondary batteries as the power source of portable electronic devices is rapidly increasing.

The lithium ion secondary battery can accumulate high energy within itself. If an internal short occurs within the lithium ion secondary battery, the energy accumulated in the lithium ion secondary battery will be discharged in a short time, resulting in the lithium ion secondary battery burning out or even exploding. To avoid those risks, the lithium ion secondary battery is provided with a variety of safety components. The safety components are commonly electrically connected with the bare cell by welding connection terminals, e.g. a lead plate, to the bare cell.

These safety components can cut off the electric connection between the bare cell and an outside electric load, resulting in prevention of flow of electric current, in cases where the battery is overcharged or excessively heated. For the safety components, a protecting circuit, a PCT (Positive Temperature Coefficient; hereafter “PCT”) element, or a bimetal may be used.

A bare cell may be accommodated in a case with safety components equipped. Alternatively, a bare cell may not be accommodated in a case. Without the use of a case, the size and the weight of a secondary battery may be reduced, resulting in the reduction of the size and the weight of portable devices equipped with secondary batteries, as well. However, secondary batteries without cases might have poor mechanical strength or heat resistance at the connecting section between the bare cell and the safety components. When external stroke is experienced, the connection section may be damaged, thereby causing safety problems in the batteries.

Further, in existing pouch type batteries, it is difficult to perform tab bending because an insulating tape is typically required for the sealing section of the pouch, which has relatively low mechanical strength. Further, because the low mechanical strength of the combination of the covering material and the PCM is correspondingly poor, safety problems may occur in the batteries.

### SUMMARY

Embodiments of the present invention increase the productivity by improving a combination of a bare cell and a PCM and fixing a position of the PCM in the bare cell.

In particular, in a pouch type secondary battery, the mechanical strength of a sealing section is improved. Therefore, bending taps is done easily without using an insulating tape. The pouch type secondary battery further may include a covering material with the top and bottom exposed. Therefore, the PCM is more firmly combined with the bare cell and the strength of the second battery is increased by the covering material, providing for a secondary battery having improved safety.

According to an embodiment, a pouch type secondary battery includes a bare cell comprising an electrode assembly and a pouch housing the electrode assembly, wherein the bare cell comprises a first side at one end of the bare cell; a molded portion covering at least a part of the first side of the bare cell; and a circuit module disposed over the molded portion.

According to another embodiment, the pouch type secondary battery further comprises at least one tab extending from the electrode assembly and the pouch, wherein the molded portion is formed along one end of the pouch, and wherein the tab is exposed through an opening in the molded portion.

According to another embodiment, the exposed tab is folded over the molded portion and parallel to the first side of bare cell. The molded portion may also further extend outwards on edges of the bare cell adjacent to the at least one lateral edge, on opposite ends of the lateral edge. The molded portion may contact substantially an entire long side of the circuit module. The molded portion further contacts sides of the circuit module adjacent to the long side, on opposite ends of the long side. The molded portion may further extend outwards on an edge of the bare cell opposite to the at least one lateral edge.

According to an embodiment, the molded portion is rounded, polygonal or rectangular at both sides of the bare cell.

According to an embodiment, the molded portion further comprises at least one structure over the first side to position the circuit module.

According to an embodiment, the molded portion comprises at least two different structures over the first side to position the circuit module.

According to an embodiment, the secondary battery further comprises a case covering the circuit module, wherein the case comprises one or more grooves; and one or more protrusions formed on a surface of the molded portion corresponding to the one or more grooves, wherein the molded portion is coupled to the case by inserting the protrusions into the grooves.

According to an embodiment, the secondary battery further comprises an adhesive to adhere the molded portion to the case.

According to an embodiment, the molded portion is formed only along an inner surface of a long side of the end of the pouch.

According to an embodiment, the molded portion is formed along inner and outer surfaces of a long side of the end of the pouch.

According to an embodiment, the secondary battery further comprises an external material around the bare cell, wherein the external material has upper and lower openings.

### BRIEF DESCRIPTION OF THE DRAWINGS

The accompanying drawings, together with the specification illustrate certain embodiments of the present invention, and, together with the description, serve to explain the principles of the present invention.

FIG. 1 is a perspective view showing the upper section of a pouch type bare cell;

FIG. 2A is a perspective view showing a conventional pouch type secondary battery;

FIG. 2B is a view showing tab-bending according for a conventional pouch type secondary battery;

FIG. 3A is a perspective view showing a pouch type secondary battery according to an embodiment of the present invention;

FIG. 3B is a view showing tab-bending of the second battery according to an embodiment of the present invention;

FIG. 4A is a view showing a side of a molding section, a PCM, and a case covering the PCM, in the second battery according to an embodiment of the present invention;

FIG. 4B is a view showing the inside of a PCM case according to an embodiment of the present invention;

FIG. 5A is a view showing a covering material and a pouch type secondary battery according to an embodiment of the present invention;

FIG. 5B is a perspective view showing a pouch type secondary battery further including a covering material according to an embodiment of the present invention;

FIG. 6 is a view showing a conventional can type bare cell; and

FIG. 7 is a view showing a can type secondary battery according to an embodiment of the present invention.

### DETAILED DESCRIPTION OF EXEMPLARY EMBODIMENTS

Embodiments of the present invention are described hereafter in detail with the accompanying drawings. However, the present invention may be changed and modified in various ways within the scope described in the claims; therefore, it can be understood by those skilled in the art that the description below only illustrates certain embodiments.

Even if the same components are shown in different figures of the drawings, it should be noted that they are represented by as many of the same reference numerals or characters as possible. In addition, the size or thickness may be exaggerated or reduced in the drawings for the convenience of description and clarity, and may be different from the thickness or size of the actual layers.

Embodiments of the present invention are described hereafter in detail with reference to the drawings.

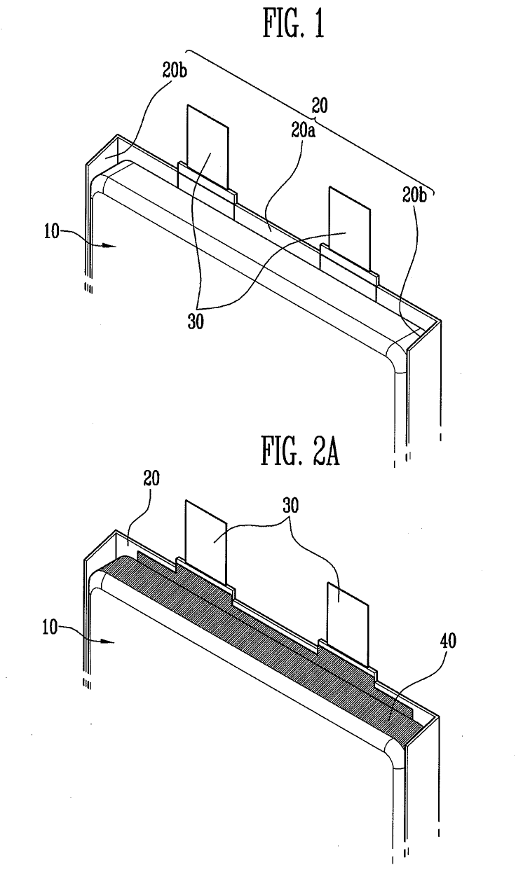

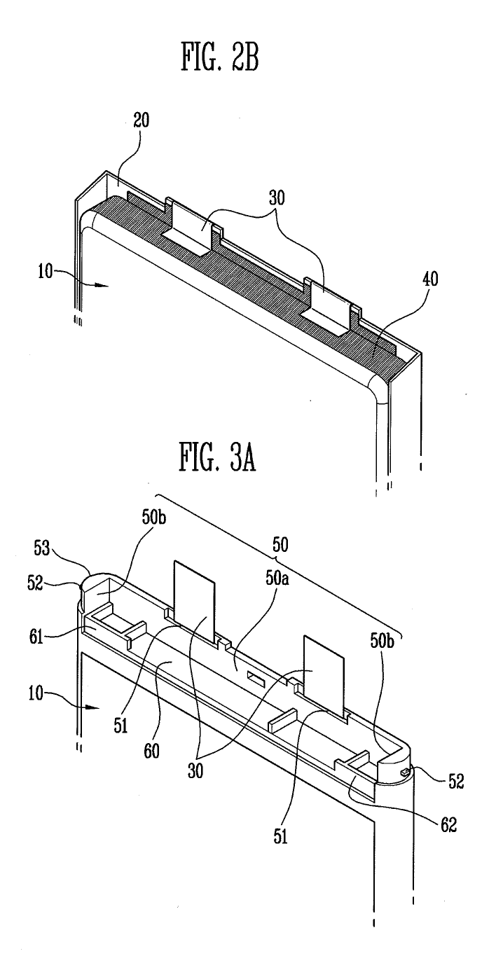

FIG. 1 is a view showing a typical bare cell for pouch type secondary batteries, and FIGS. 2A and 2B are views showing the attachment of an insulating tape to the sealing section of a bare cell and the tap is bent according to the related art.

Referring to FIG. 1, a bare cell 10 is formed by inserting an electrode assembly into a pouch. The electrode assembly typically includes a negative plate, a positive plate, and a separator. Further, the electrode assembly has taps 30 electrically connected with the plates, respectively. The bare cell 10 shown in FIG. 1 is included in a pouch type secondary battery. The pouch type secondary battery includes a sealing section 20 sealing the pouch. The taps 30 are partly exposed to the outside through the sealing section 20, respectively. The sealing section 20 is formed by applying heat and/or pressure to the edge of the pouch, using a heat-sealable material.

In FIGS. 2A and 2B, bending the taps 30 improves the electrical connection between the PCM and the bare cell 10. An insulating tape 40 is attached to the contact section of the pouch and the taps 30, before bending the taps 30. The insulating tape 40 is provided only to prevent the short circuit with no other function, even though it is quite expensive. Further, the sealing section 20 does not have enough strength to support the taps 30 in bending. Accordingly, it is difficult to uniformly bend the taps 30.

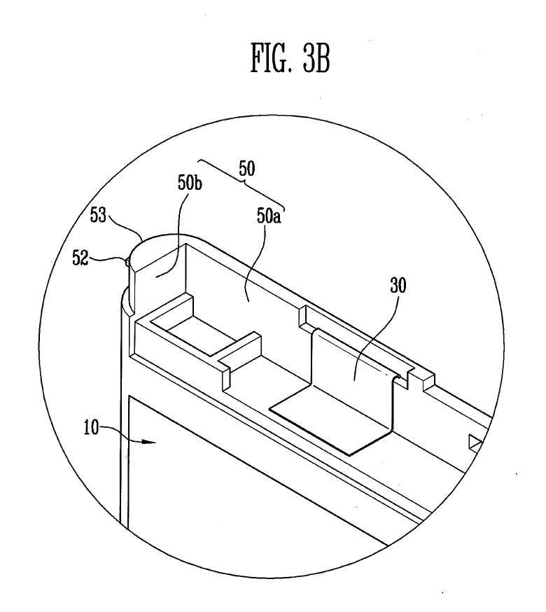

FIGS. 3A and 3B show a second battery according to the present invention, in which a molding section is formed at the sealing section of a pouch and the molding section has a stepped height.

A pouch type secondary battery according to embodiments comprises a PCM, a case covering the PCM, a bare cell including an electrode assembly, and a pouch accommodating the electrode assembly. The pouch has a sealing section, through which taps 30 are partly exposed. The sealing section may include a molding section, and the molding section and a PCM mounting section may be formed on at least one side of the bare cell.

Referring to FIGS. 3A and 3B, the sealing section of the pouch has a molding section 50 between the pouch and the PCM, formed in the sealing section of the pouch. The molding section 50 may cover only one cross section 50a of the PCM in the sealing section. The molding section 50 also may cover one cross section 50a and both sides 50b of the PCM. Preferably, the molding section 50 covers the whole sealing section that contacts the PCM.

The molding section 50a formed on the long side cross section of the sealing section can prevent a short circuit. The molding section 50a also may have functions similar to a conventional insulating tape in the process of bending the taps 30. In addition, the molding section 50 may increase the mechanical strength of the sealing section 20.

The molding section 50 may cover both the sides and the bottom of the bare cell 10. The shape of the molding section 50 may be modified into a flat plane shape, a polygonal shape, or a rounded shape. The shape depends on the design of the secondary battery. FIGS. 3A-3B show a rounded shape 53. As described above, the molding section 50 covering the sides of the bare cell 10 functions as a case for the secondary battery. In addition, the secondary battery should have a certain mechanical strength, even without an additional case.

The molding section 50 may include a PCM mounting section 60. The PCM mounting section 60 is where the PCM is positioned in the bare cell 10. The PCM mounting section 60 may be formed on any side of the bare cell 10. Preferably, the PCM mounting section 60 is formed adjacent to the tabs.

Further, as shown in FIGS. 3A and 3B, the PCM mounting section 60 may include PCM mounting structures 61 and 62. The PCM mounting structure may be one or more, and include the first and second mounting structures 61 and 62. The first and second mounting structures 61 and 62 are shown in FIG. 3A. Preferably, the shapes of the first and second mounting structures 61 and 62 are different. The first and second mounting structures 61 and 62 can prevent the reverse insertion of the terminal of the PCM in the bare cell 10. Therefore, the process of combining the PCM with the bare cell 10 is simplified, such that it is possible to reduce the rate of errors.

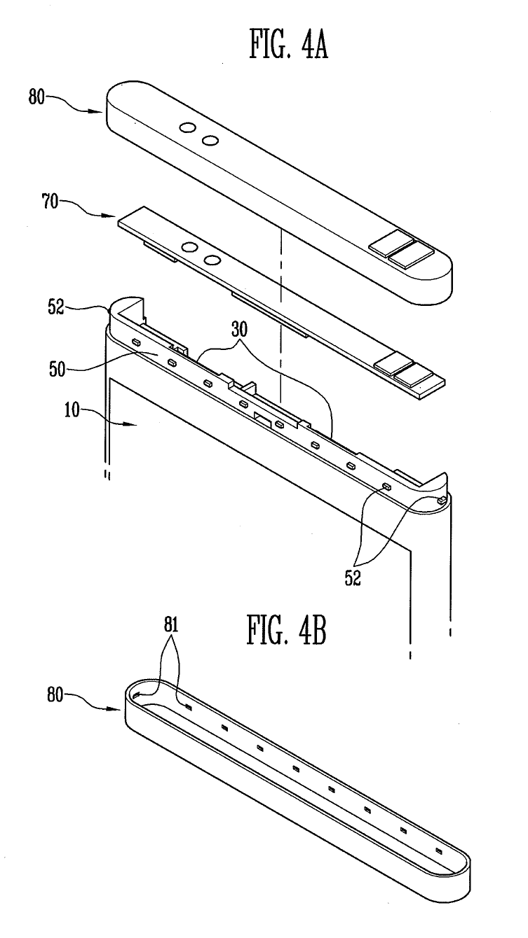

FIG. 4A shows an embodiment where the PCM and the case covering the PCM are connected to the molding section, and FIG. 4B shows the inside of the case.

In FIG. 4A, one or more protrusions are formed at the lower portion on the outside of the molding section 50, and one or more grooves 81 are formed at positions corresponding to the protrusions 52 in the case 80 covering the PCM. After the taps 30 are bent, the PCM 70 is placed in the PCM mounting section. Thereafter, the case 80 covers the molding section 50 and the PCM 70 of the bare cell 10. At this point, the case 80 contacts the outside of the molding section 50, and the protrusions 52 combines with the grooves 81 (FIG. 4B).

In FIG. 4A, the protrusions 52 are formed at the lower portion on the outside of the molding section 50, and the grooves 81 are formed at the positions corresponding to the protrusions in the case 80. Therefore, the protrusions and grooves have only to be formed at the positions corresponding to each other, such that the position and the number of the protrusions and grooves can be properly modified in accordance with the design of the secondary battery. In addition, adhesive materials may be further used to secure a more firm combination. Alternatively, it is possible to use only adhesive materials such as glue when the protrusions or the grooves are not formed.

Referring to FIGS. 2A and 2B, the conventional pouch type secondary battery had the problem of low mechanical strength of the sealing section 20 and the taps 30. Therefore, it was difficult to bend the taps 30, and the bending shapes were not uniform.

In FIGS. 3A-3B, the sealing section of the secondary battery according to an embodiment of the present invention has improved mechanical strength by the presence of molding section 50. The molding section can be formed only inside the long side of the sealing section. In addition, the molding section can further have a molding surface covering the outside of the long side of the sealing section. Preferably, the molding surfaces have the stepped height 51 where the taps 30 of the sealing section are formed. Preferably, the lower section is inside. The molding section 50 makes the sealing section stronger, and the stepped height 51 makes bending the taps 30 easier. Therefore, the bent taps have a uniform shapes (see FIG. 3B).

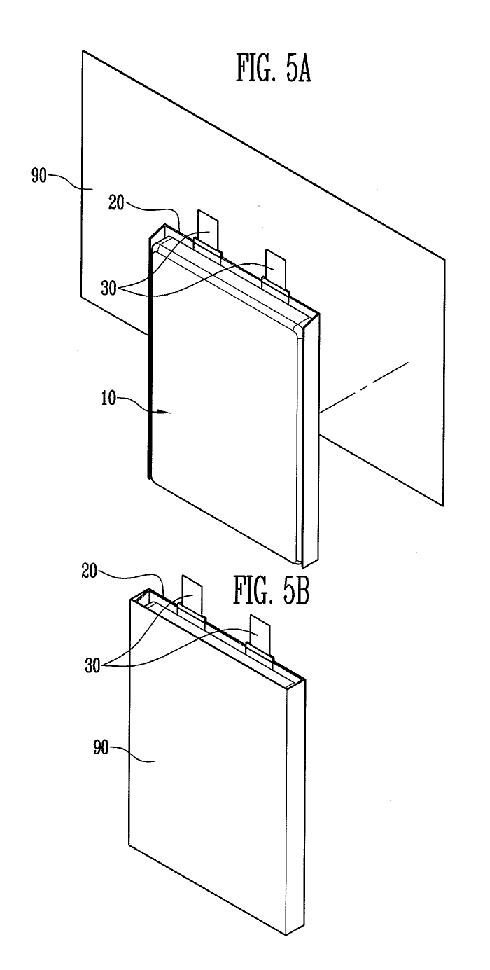

On the other hand, FIGS. 5A-5B are views showing a pouch type secondary battery according to another embodiment of the present invention. The pouch type secondary battery further includes a covering material with the top and bottom open.

FIG. 5A shows a covering material and a bare cell before a molding section is formed in a sealing section, and FIG. 5B shows the bare cell including the covering material.

In a pouch type secondary battery according to embodiments, the bare cell 10 includes the covering material 90. As described above, the covering material 90 may cover the bare cell 10 before the molding section is formed in the sealing section 20. The covering material 90 may cover the bare cell 10 without the top and bottom of bare cell. The bare cell 10, except for the top and bottom, is partially or entirely enclosed by the covering material 90. Preferably, as shown in the figure, the bare cell 10 is entirely enclosed except for the top and bottom of bare cell. Further, any one of the top and bottom opening parts may include the sealing section with the taps 30. In FIG. 5, the taps of the bare cells are exposed.

The covering material may be a sheet shape or a tube shape. In a sheet shape, as shown in the figure, the sheet-shaped covering material 90 covers the bare cell 10. One edge and the other edge of the covering material 90 may be attached by an adhesive material, such as glue (see FIG. 4). Alternatively, the bare cell 10 may be inserted into the covering material when the covering material is a tube shape.

In the bare cells further including the covering material 90 according to embodiments, the covering material 90 supports the secondary battery, such that the mechanical strength of the sealing section is improved. Therefore, it is possible to more easily form the molding section and more firmly combine the bare cell 10 with the PCM.

Further, the covering material 90 can increase the mechanical strength of the secondary battery. Since the covering material is a non-conducting material, the secondary battery is afforded electrical safety. The pouch type secondary battery further includes the covering material 90 according to embodiments of the present invention. The covering material 90 increases the mechanical strength of the secondary battery, and allows the secondary battery to meet electrical safety requirements.

An embodiment of a can type secondary battery according to another aspect of the present invention is described hereafter.

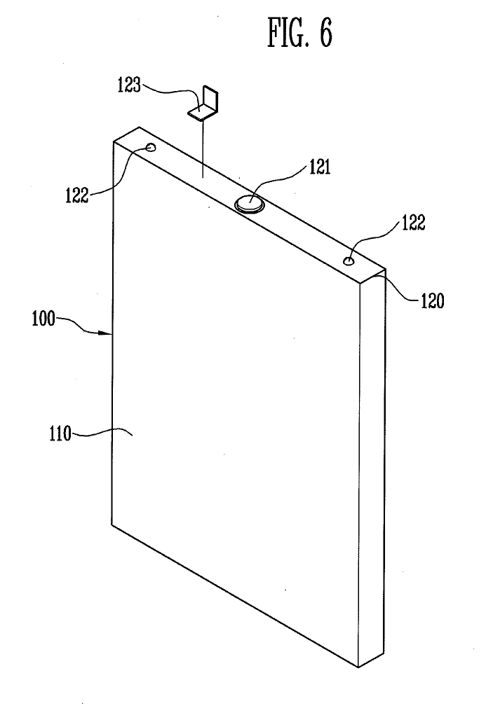

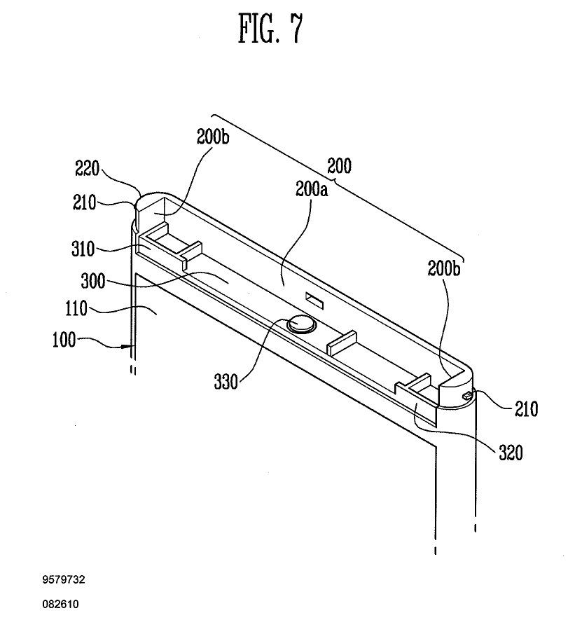

FIG. 6 shows a can type bare cell and a lead plate, and FIG. 7 shows a can type secondary battery having the molding section according to embodiments of the present invention.

Referring to FIG. 6, an electrode assembly (not shown) includes a negative plate, a positive plate, and a separator. The electrode assembly accommodated in a can 110, and a cap assembly 120 closes the opening of the can 110 using a welding process.

In a conventional can type secondary battery, several components would be required to fix the PCM to a bare cell 100 and electrically connect it to the exterior of the battery. As shown in FIG. 6, fixing protrusions 122 would be needed to fix the position of the PCM on the cap assembly for conventional batteries. Moreover, a terminal component, such as the lead plate 123 would be weld to the cap assembly for electrical connection with the bare cell 100. The material cost of the battery was increased by the fixing protrusions 122 and the lead plate 123, and the manufacturing cost of the battery was increased by the additional processes, such as welding. Furthermore, the protrusions 122 and the lead plate 123 are not sufficient in stably fixing, physically and electrically, the PCM etc. to the bare cell 100.

Therefore, a can type secondary battery according to embodiments of the present invention includes a PCM, a case covering the PCM, an electrode assembly, a can, and a cap assembly. The can accommodates the electrode assembly, and the cap assembly closes an opening of the can. Further, at least one side of the bare cell includes a molding section and a PCM mounting section thereon.

Unlike the conventional secondary battery, in the secondary battery according to embodiments of the present invention, the molding section is formed to fix and electrically connect the PCM the bare cell. Therefore, the secondary battery according to embodiments of the present invention does not need fixing protrusions or a lead plate.

FIG. 7 is a view showing a can type secondary battery according to an embodiment of the present invention.

Referring to FIG. 7, the molding section 200 is formed at the top of the bare cell 100 and positioned between the bare cell and the PCM.

The molding section 200 may be in contact with only one cross section 200a of the PCM. Alternatively, the molding section 200 may cover one cross section 200a and both sides 200b of the PCM. The larger the contact area between the molding section 200 and the PCM, the more the PCM is firmly combined with the bare cell 100. Further, the molding section 200 may be in partial or entire contact with the cross section of the PCM. Preferably, the molding section 200 is in contact with the entire cross section of the PCM. In the figure, the molding section 200 is in contact with one long side and both cross sections of the PCM.

The molding section 200 may be formed on any section of the bare cell 100. However, it is preferable to be formed on the cap assembly (120 in FIG. 6) to be easily electrically connected with the PCM.

The molding section may extend, for example, to include both sides and bottom of the bare cell 100. The molding section extending at both sides of the bare cell 100 may be properly modified depending on the design of the secondary battery. For example the shape of the molding section may have a flat plane shape, a polygonal shape, or a rounded shape. FIG. 7 shows an embodiment in which the molding section 200 has a rounded shape. The molding section covering the sides of the bare cell, as described above, can function as a case of the secondary battery. Therefore, it is possible to improve mechanical strength of the conventional can type secondary battery, even without adding a case to the secondary battery. Further, it was difficult to implement changes to the appearance of the conventional can type secondary battery in accordance with changes in the design of electronic devices. In the can type secondary battery according to embodiments of the present invention, it is possible to easily change the appearance of the can type secondary battery by simply changing the shape of the molding section.

Further, the molding section 200 may include a PCM mounting section 300. The PCM mounting section 300 is where the PCM is seated in the bare cell 100 and may be formed on any side of the bare cell 100. It is preferable to form the PCM mounting section to a section where an electrode 121 of the bare cell 100 is formed, in order to easily form an electrode 121 in the PCM mounting section 300.

As shown in FIG. 7, the PCM mounting section 300 may include PCM mounting sections 310 and 320. The PCM mounting structure may be one or more. In FIG. 7, the first and second mounting structures 310 and 320 are shown. Preferably, the shapes of the first and second mounting structures 310 and 320 are different. The first and second mounting structures 310 and 320 can prevent the reverse insertion of the terminal of the PCM in the bare cell 10, and fix the position of the PCM.

As described above, the molding section 200 can include protrusions 210, and the case covering the PCM can include one or more grooves. The protrusions 210 may be formed at the lower portion on the outside of the molding section 200, and the grooves corresponding to the protrusions may be formed on the case covering the PCM. The molding section 200 and the case covering the PCM can be combined by the protrusions and the grooves. The bare cell 100 may be combined with the PCM and then the PCM may be covered with the case. In this structure, the case is in contact with the outside of the molding section and combined with the molding section at the contact sections by the protrusions and the grooves. The sections with the protrusions and the grooves have only to correspond to the protrusions and the groove, without being fixed. In addition, it is possible to achieve the combination with adhesive materials such as glue when the protrusions or the grooves are not formed.

What is claimed is:

1. A secondary battery comprising:
a bare cell comprising an electrode assembly and a pouch housing the electrode assembly, wherein the bare cell comprises a first side at one end of the bare cell;
a molded portion covering at least a part of the first side of the bare cell; and
a circuit module disposed over the molded portion.

2. The secondary battery of claim 1, wherein the molded portion extends outwards from the first side on a first lateral edge of the bare cell.

3. The secondary battery of claim 1, further comprising:
at least one tab extending from the electrode assembly and the pouch, wherein the molded portion is formed along one end of the pouch, and wherein the tab is exposed through an opening in the molded portion.

4. The secondary battery of claim 3, wherein the exposed tab is folded over the molded portion and parallel to the first side of bare cell.

5. The secondary battery of claim 2, wherein the molded portion further extends outwards on side edges of the bare cell at opposite ends of the first lateral edge.

6. The secondary battery of claim 1, wherein the molded portion contacts substantially an entire long side of the circuit module.

7. The secondary battery of claim 5, wherein the molded portion further contacts sides of the circuit module adjacent to the long side, on opposite ends of the long side.

8. The secondary battery of claim 2, wherein the molded portion further extends outwards on a second lateral edge of the bare cell opposite to the first lateral edge.

9. The secondary battery of claim 1, wherein the molded portion is rounded, polygonal or rectangular at both sides of the bare cell.

10. The secondary battery of claim 1, wherein the molded portion further comprises at least one structure over the first side to position the circuit module.

11. The secondary battery of claim 1, wherein the molded portion comprises at least two different structures over the first side to position the circuit module.

12. The secondary battery of claim 1, further comprising:
a case covering the circuit module, wherein the case comprises one or more grooves; and
one or more protrusions formed on a surface of the molded portion corresponding to the one or more grooves, wherein the molded portion is coupled to the case by inserting the protrusions into the grooves.

13. The secondary battery of claim 12, further comprising an adhesive to adhere the molded portion to the case.

14. The secondary battery of claim 2, wherein the molded portion is formed only along an inner surface of a long side of the end of the pouch.

15. The secondary battery of claim 2, wherein the molded portion is formed along inner and outer surfaces of a long side of the end of the pouch.

16. The secondary battery of claim 2, further comprising an external material around the bare cell, wherein the external material has upper and lower openings.
